(19) United States
(12) Patent Application Publication
(10) Pub. No.: US 2025/0009004 A1
(43) Pub. Date: Jan. 9, 2025

(54) JUICER

(71) Applicant: Raja Singh Tuli, Montreal (CA)

(72) Inventor: Raja Singh Tuli, Montreal (CA)

(21) Appl. No.: 18/735,819

(22) Filed: Jun. 6, 2024

Related U.S. Application Data
(60) Provisional application No. 63/525,023, filed on Jul. 5, 2023.

(51) Int. Cl. A23N 1/02; A23L 2/04

(52) U.S. Cl. CPC A23N 1/02; A23L 2/04

(57) ABSTRACT

The present invention provides an apparatus and a method for extracting fruit juice in a rarefied argon gas environment. The invention also provides a method of preserving flavor and nutrients of the extracted fruit juice. The invention provides a juicer with at least two chambers-a rigid chamber and a juicing chamber. The rigid chamber includes a vacuum bag to hold fruits and vegetables after cleaning, which can be vacuum-packed and placed inside the rigid chamber. The juicing chamber houses a juicer machine and can be filled with rarefied argon gas. The juicer machine extracts the juice from the fruits in a rarefied argon gas environment and the extracted juice can then be packed in the packaging bottles. The overall objective of the invention is to reduce argon gas loss during the entire juicing and packaging process.

### CROSS-REFERENCE TO RELATED APPLICATIONS

This application claims priority to U.S. provisional patent application No. 63/525,023, entitled “JUICER,” filed on Jul. 5, 2023. The content of this U.S. provisional patent application is hereby incorporated by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to the field of improving processes for manufacturing and packaging fruit and vegetable juice in noble gases environment. More particularly, the invention relates to a method and apparatus for producing fruit and vegetable juice in an argon gas environment. The invention also relates to the technical field of consumer goods industries, particularly related to a type of fruit and vegetable juicers.

### Description of Related Art

Over time, various devices have been created for extracting fresh juice from fruits and vegetables, catering to both home and commercial markets. The primary function of these juicers is to separate the juice from the pulp, making it easier for consumers to enjoy the juice. There are various types of juicers available in the market, each operating on different principles. Centrifugal-type juicers operate by feeding food matter through a chute or entrance, where a set of high-speed rotating mechanical blades cut and/or grind the food matter into a pulp. Centripetal force is then applied by rapidly spinning the food matter, which separates the juice from the pulp through a filter. Another type of juicer suitable for home and retail use is the masticating juicer, which employs an auger to crush the food matter into pulp. The auger further compresses the pulp, forcing the juice through a filter. The hydraulic press juicer is yet another kind, utilizing hydraulic pressure to compress food matter between one or more surfaces that are in direct contact with the food matter, effectively extracting the juice.

The aforementioned juicing methods involve crushing fruits and vegetables in an air-filled environment. However, it is important to note that during the juice extraction process, the fruits, vegetables, and juicer components come into contact with air. When the flesh of most fruits is exposed to air, even for a short period, oxidation occurs, leading to changes in the nutrition and flavor of the juice. This can result in degradation of the nutrient content and flavor of the juice.

Previously, techniques and devices were utilized to minimize the oxidation of fruit juice by utilizing inert gases. U.S. Pat. No. 3,183,171 specifies that argon and other inert gases can affect the growth rate of fungi, and argon can enhance the preservation of packaged food. Conventionally, liquid foods, including fruit juices or other beverages, are preserved during storage by using inert or non-reactive gases to displace atmospheric oxygen from their immediate vicinity. This is because oxygen has been shown to degrade many of the aroma and flavor components of the substances.

U.S. Pat. No. 3,714,887 outlines a technique for crushing fruits and vegetables in an environment filled with inert gas. The method involves using an enclosed fruit-crusher to prevent the entry of oxidizing air into the crusher or juice tank during crushing. However, these methods fail to address the degradation of fruits and vegetables during storage or pre-crushing processing, before being crushed into a juicer. The fruits and vegetables may come into contact with air and undergo oxidation, leading to degradation of the nutrient content and flavor of the prepared juice.

The patent document WO2007017200A2 details a method and system for producing fruit or vegetable juice in an environment filled with inert gas. The method involves utilizing a pre-pre-shredding device that can enclose the fruits and vegetables to be crushed under protective gases such as N2 or CO2. However, the use of N2 and CO2 may not offer the most optimal preservation environment.

There is accordingly a need for an improved fruit and vegetable juicer and juice extraction process which performs the fruit and vegetable storage and juice extraction process in an argon gas environment.

It is therefore an object of the present invention to extract juice from fruits and vegetables in a more efficient manner such that natural flavour and nutrients are preserved in the extracted juice. Further, the invention relates to a method and apparatus for extracting the juice from the fruits and vegetables in a rarefied argon gas environment. The invention can improve the juicing process by eliminating the oxidation of the fruits and the juice and preserve the nutrient content and flavor of the prepared juice.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to improving processes for manufacturing and packaging of fruit and vegetable juice in noble gases environment. More particularly, the invention relates to a method and apparatus for producing fruit and vegetable juice in an argon gas environment. The invention also relates to the technical field of consumer goods industries, particularly related to a type of fruit and vegetable juicers.

In a preferred embodiment of the present invention, an apparatus and a method for extracting and packaging fruit juice in a rarefied argon gas environment are disclosed. The invention provides a juicer with at least two chambers-a rigid chamber and a juicing chamber. The rigid chamber includes a vacuum bag to hold fruits and vegetables after cleaning, which can be vacuum-packed and placed inside the rigid chamber. The juicing chamber houses a juicer machine and can be filled with rarefied argon gas. The juicer machine extracts the juice from the fruits in a rarefied argon gas environment and the extracted juice can then be packed in packaging bottles. The rigid chamber and juicing chamber can be connected to inject the rarefied argon gas into the vacuum bag. The system can reclaim the argon gas from the vacuum bag after the juice extraction process is complete, which eliminates the wastage of expensive argon gas.

According to another embodiment of the invention, the method involves the extraction of fruit juice in a rarefied argon gas environment. The method includes using a vacuum system to decrease air pressure within a rigid chamber to draw rarefied argon gas into a vacuum bag from a juicing chamber. Juice is extracted from fruits in a rarefied argon gas environment using a juicer machine. After the fruits are emptied, the pressure is released, and the rarefied argon gas is reclaimed into the juicing chamber. The juice is dispensed in a dispensing area that may contain an array of cavities designed to receive small packaging containers. The packaging of juice in small bottles should be performed in a rarefied argon gas environment to preserve the nutrient content, flavor, and quality of the juice.

According to another embodiment of the invention, the juicing chamber can have one or more cavities for holding packaging bottles to fill with juice extracted by the juicer machine. The bottles can be covered with plastic and placed in the cavities, which can have holes through which the bottles can be pulled once filled. A cover then closes the holes to prevent rarefied argon gas from escaping. Alternatively, the bottles can be placed in the cavities in a way that prevents argon gas from escaping. An array of holes can be provided in the dispensary area, and the bottles can be pushed and sealed into the holes with a rubber cover to minimize argon loss. Cylindrical bottles can be used to prevent gas loss while removing the filled bottles. The overall objective of the invention is to reduce argon gas loss during the entire juicing and packaging process.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective front view of an example juicer apparatus in accordance with the subject disclosure.

FIG. 2 is a perspective view of the secondary chamber of the juicer apparatus according to the primary embodiments of the invention.

FIG. 3 is another perspective view of the secondary chamber of the juicer apparatus according to alternate embodiments of the invention.

FIG. 4 is a perspective view of the juicer apparatus according to an alternate embodiment of the invention.

FIG. 5 is a flow diagram illustrating the operation of the juicing apparatus in accordance with the various embodiments.

### DETAILED DESCRIPTION

The subject disclosure is directed to improving processes for manufacturing and packaging fruit and vegetable juice in noble gases environment. More particularly, the invention relates to a method and apparatus for producing fruit and vegetable juice in an argon gas environment.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, a variety of crops, including both fruits and vegetables, are used to produce juice. It is important to note that the term “fruit” is used throughout the detailed description as a synonymous term for the material being processed to make juice. It should be understood by individuals with ordinary skill in the art that the term is used to refer to any type of fruit or vegetable that can be used to make juice.

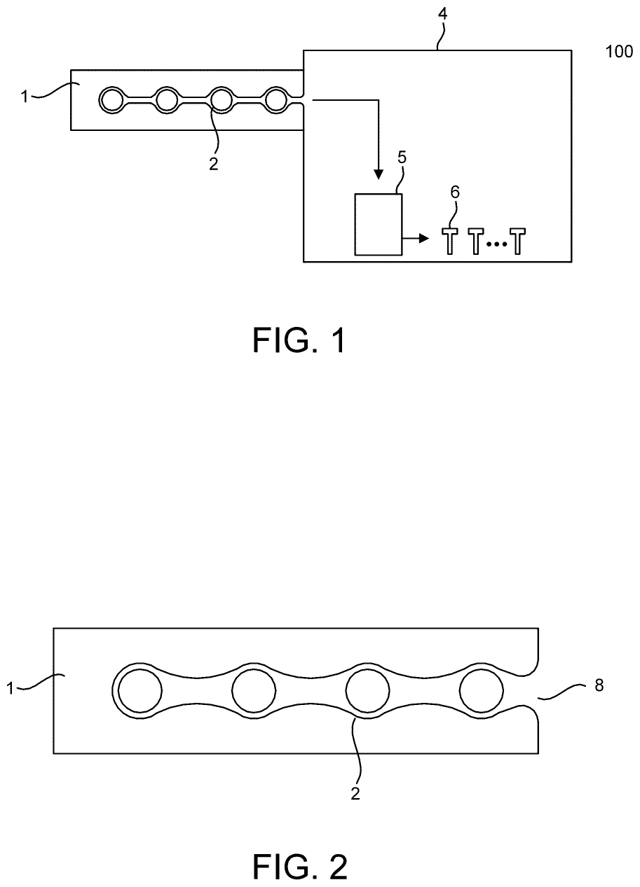

FIG. 1 discloses a juicer 100 for extracting juice from the fruits and vegetables. In a preferred embodiment, the juicer 100 can include at least two chambers-a rigid chamber 1 and a juicing chamber 4. In exemplary embodiments, the rigid chamber 1, or other appropriate fruit receiving compartments, constructed and arranged to receive one or more types of fruits. It should be understood that rigid chamber 1 may be sized and/oriented to receive any number of fruits. However, for case of illustration, the rigid chamber 1 is, at times, shown and/or described with a single type of fruit. According to a primary embodiment of the invention, the rigid chamber I can include a vacuum bag 2, adapted to receive fruits and vegetables after cleaning. The fruits and vegetables can be vacuum packed in the bag 2 by removing air using an appropriate vacuum system. In the preferred embodiments, the vacuum packed fruits and vegetables can be placed inside the rigid chamber I such that one end of the bag 2 can open inside the juicing chamber. The rest of the space inside the rigid chamber 1 remains filled with air. According to a primary embodiment of the invention, the juicing chamber 4 is constructed and arranged to house a juicer machine 5 and one or more cavities 6 for receiving packaging bottles for packing the extracted juice from the fruits. In the preferred embodiments, the juicing chamber 4 can be filled with rarefied argon (Ar) gas. According to a primary embodiment of the invention, the rigid chamber 1 and the juicing chamber 4 can be connected together in such a manner that the rarefied argon gas can be injected into the vacuum bag 2 through an opening 8. According to one embodiment of the invention, the juicer 100 may be an electrically powered tabletop appliance. In some embodiments of the invention, it should be understood that the juicer may be powered using any appropriate power source including but not limited to, a power line, battery, generator, a pneumatic pressure source, a hydraulic power source, or any other appropriate power source.

In the preferred embodiment of the invention, a suitable vacuum system can be used to reduce the air pressure inside the rigid chamber I to create a rarefied environment. In some embodiments of the invention, the pressure of the rarefied air can be reduced to half of the atmospheric pressure. In some embodiments of the invention, the pressure of the rarefied air can be reduced to one third of the atmospheric pressure. The rarefied air environment around the vacuum bag 2 creates pressure on the vacuum bag which may eventually lead to pulling the rarefied argon gas into the vacuum bag 2 from the juicing chamber 4 through the opening 8. As shown in FIG. 2, the vacuum bag 2 may expand as the rarefied argon gas is pulled inside through the opening 8. In the preferred embodiment of the invention, the fruits inside the bag 2 can be dropped inside the juicing chamber 4. The juicer machine 5, provided for extracting the juice can crush the fruits, can extract the juice contained therein and discharge the solid fruit residue. According to the primary embodiment of the invention, the juicer machine 5 extracts the juices from the fruits in a rarefied argon gas environment. The rarefied argon gas environment can eliminate the oxidation of the fruits and the juice and preserve the nutrient content and flavor of the prepared juice.

In a preferred embodiment, as soon as all fruits from the vacuum bag 2 drop into the juicing chamber for extracting the juice, the bag 2 contains only rarefied argon gas. The system may start the process of reclaiming the argon gas from the vacuum bag 2. In some embodiments of the invention, an automatic computer-controlled valve can be used to release the pressure of the rigid chamber 1. The air coming into the rigid chamber 1 may push the rarefied argon gas from the vacuum bag 2 to the juicing chamber 4. Throughout the process, first, the rarefied argon gas can be used for inflating the vacuum fruit bag 2 so that fruits can be used for extracting the juice and next, once the vacuum bags are empty with fruits, the argon gas can be reclaimed by applying air pressure in the rigid chamber 1. In the preferred embodiment of the invention, the juicer 100 can eliminate the wastage of expensive argon gas during the juicing process.

The juicer 100 may be provided with various electronic components for facilitating user interaction. Juicer 100 may include a controller for controlling the juicer and directing operations of the various components of the apparatus (e.g., pressure control valves, juicer machine, etc.) in response to user input. The juicer 100 may also incorporate other means of operation, such as an on/off switch. The controller may take the form of an embedded system, a system-on-a-chip (SoC) integrated circuit, a microcontroller, or any other configuration that may be known in the art. In exemplary embodiments, the user can control the juicer 100 through a LCD touchscreen that displays various options and information. Moreover, the juicer 100 can be configured to interact with a user's smart phone, tablet, or laptop by Bluetooth, WiFi, or other communications medium.

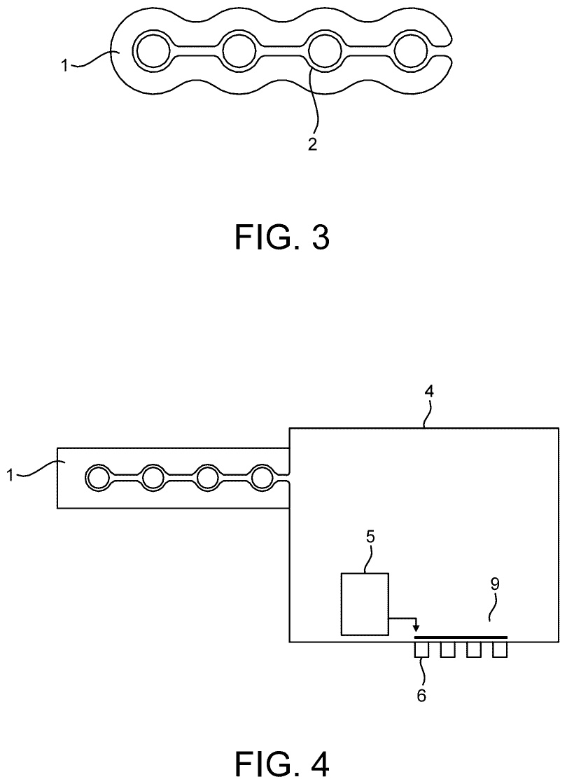

In some embodiments of the invention, the rigid chamber I can be provided in various shapes and sizes according to the sizes and shapes of the fruits. FIG. 3 shows another perspective view of the rigid chamber I according to an embodiment of the invention. The shape and size of the rigid chamber I can be selected in such a manner that the minimum power is required to create rarefied air environment around the vacuum bag 2.

In the preferred embodiment of the invention, the juicer machine 5 can apply compressive force to the fruits to extract the liquid (e.g. juice) contained therein. In other embodiments of the invention, any suitable method of extracting the juice may be used without deviating from the scope of the invention. The extracted juice may flow through the juicer machine outlet to an exterior of the machine 5. In some embodiments, the juicer machine 5 may have a dispensary area where juice may be dispensed from. As depicted in FIGS. 1 and 4, a dispensing area 9 may be embodied by a region defined in the juicing chamber 4 and may further include an array 6 of cavities for receiving small packaging containers (e.g. bottles). In some embodiments, and as depicted in the figures, the outlet of the juicer machine may be formed within the dispensing area 9. Therefore, the extracted juice flowing out of the outlet may be dispensed into packaging containers. According to the preferred embodiment of the invention, the packaging of the juice in the small bottles should be performed in a rarefied argon gas environment.

In a preferred embodiment of the invention, as shown in FIG. 4, the juicing chamber 4 may comprise one or more cavities 6 in the dispensary area for receiving packaging bottles for packing the juice extracted from the fruits by the juicer machine 5. One or more cavities 6 may be covered with rigid or very thin plastic covers shrinking around the bottles. In some embodiments of the invention, one or more packaging bottles can be placed in the cavities created for the purpose of placing the packaging bottles while filling the extracted juice in the rarefied argon environment. In some embodiments of the invention, the bottles can be pulled through the holes once the juice is filled. As soon as the bottles come out of the holes, a cover provided to protect the argon gas, closes the gates so that rarefied argon gas can not escape.

According to another embodiment of the invention, the bottle for packing the juice can be placed in the cavity in such a manner that the juice can be filled into the bottle and no argon gas can escape. The holes on the top of the cavity are made with rubber such that once the bottle goes into the holes, none of the air goes through the holes into the juicing chamber 4. In some embodiments, there is an array of holes provided in the dispensary area. The bottles can be pushed and sealed into the holes with a rubber cover in such a manner that no argon is lost. The overall objective of the provided mechanism is to minimize the rarefied argon gas loss from the juicing chamber 4, throughout the juicing and packaging process.

In a preferred embodiment of the invention, the packaging bottles may be designed in a cylindrical shape so that there is no argon gas loss while removing the filled bottles from the packaging cavities. In another embodiment, a sphincter-like mechanism can be used in such a manner that it seals and holds the packaging bottles against the outside elements. The sphincter mechanism can be variable in diameter in accordance with the shape of the bottles so that it minimizes argon gas loss.

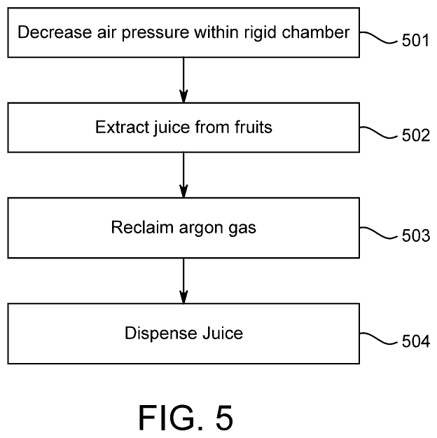

FIG. 5 is a flowchart illustrating a method of extracting fruit juice in a rarefied argon gas environment in accordance with various embodiments of the invention.

The method described herein involves a process wherein, at step 501, a vacuum system can be employed to decrease the air pressure within the rigid chamber 1. In certain embodiments of the invention, the pressure of the rarefied air in the rigid chamber 1 may be reduced to half of the atmospheric pressure, while in other embodiments, the pressure may be reduced to one-third of the atmospheric pressure. The rarefied air environment around the vacuum bag 2 may generate a pressure capable of drawing the rarefied argon gas into the vacuum bag 2 from the juicing chamber 4 through the opening 8. This process can be visualized in FIG. 2, where the expansion of the vacuum bag 2 occurs as the argon gas is pulled inside the vacuum bag.

The next step, step 502, involves the juicer machine 5 extracting juice from the fruits that have been deposited into the juicing chamber 4 from the vacuum bag 2. The primary embodiment of the invention involves the application of a compressive force by the juicer machine 5 to extract the juice from the fruits in an environment of rarefied argon gas. However, in alternative embodiments of the invention, any suitable method for extracting juice may be employed. The preferred embodiment of the invention utilizes the rarefied argon gas environment to prevent oxidation and maintain the nutrient content and flavor of the resulting juice.

In step 503, after all the fruits have been emptied from the vacuum bag 2 into the juicing chamber 4 for juice extraction, the vacuum bag 2 contains only rarefied argon gas. At this point, the method involves releasing the pressure within the rigid chamber 1, which results in the reclamation of the argon gas back into the juicing chamber 4. The method can accomplish reclaiming the argon gas by pushing air into the rigid chamber 1, which in turn pushes the rarefied argon gas into the juicing chamber 4.

In step 504, the juice extracted by the juicer machine 5 in the rarefied argon gas environment can be dispensed. The juice may flow through the juicer machine outlet and out to the exterior of the machine. The dispensing area 9 of the juicer machine 5 may contain an array 6 of cavities that are designed to receive small packaging containers such as bottles. In some embodiments of the invention, the dispensing area 9 may include an array 6 of cavities for receiving the packaging bottles.

It is important to note that in the preferred embodiment of the invention, the packaging of the juice in small bottles should be performed in a rarefied argon gas environment to preserve the nutrient content, flavor, and quality of the juice.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A juicer comprising:
a primary chamber;
a secondary chamber for receiving the fruits from outside and providing the fruits to the primary chamber; and
a flexible package for storing fruits while reducing the air around the fruits,
wherein the flexible package expands and pulls the rarefied argon gas from the primary chamber when the outside air of the flexible package is rarefied, allowing the fruits to go into the main chamber, and collapses the flexible package again to release the rarefied argon gas in the primary chamber.

2. The juicer of claim 1 wherein, the primary chamber is filled with rarefied argon gas.

3. The juicer of claim 1 wherein, the primary chamber comprises a juice extracting machine.

4. The juicer of claim 1 wherein, the secondary chamber is made with rigid material.

5. The juicer of claim 1 wherein, the secondary chamber is made in various shapes according to shapes of the fruits.

6. The juicer of claim 1 wherein, the secondary chamber can be made with flexible material to take the shape of the fruits placed inside the chamber.

7. A method of extracting fruit juice in a rarefied argon gas environment, comprising:
decreasing the air pressure within a rigid chamber using a vacuum system;
extracting juice from fruits deposited into a juicing chamber from a vacuum bag using a juicer machine;
emptying all fruits from the vacuum bag into the juicing chamber for juice extraction, wherein the vacuum bag contains only rarefied argon gas; and
releasing the pressure within the rigid chamber, resulting in the reclamation of the argon gas back into the juicing chamber.

8. The method of claim 7, wherein the vacuum system comprises a device for reducing the air pressure within the rigid chamber to create a rarefied argon gas environment.

9. The method of claim 7, wherein the rarefied argon gas within the vacuum bag is obtained by removing air and introducing argon gas into the bag.

10. The method of claim 7, wherein the fruit juice extracted in the rarefied argon gas environment maintains its quality and nutritional properties due to reduced exposure to oxygen.

11. A method of extracting fruit juice in a rarefied argon gas environment, comprising:
providing a rigid chamber in various shapes and sizes according to the sizes and shapes of the fruits, wherein the shape and size of the rigid chamber are selected to minimize the power required to create a rarefied air environment around a vacuum bag;
creating a rarefied air environment around the vacuum bag;
extracting juice from fruits deposited into a juicing chamber from the vacuum bag using a juicer machine;
reclaiming the argon gas back into the juicing chamber by pushing air into the rigid chamber; and
dispensing the juice extracted by the juicer machine in the rarefied argon gas environment.
